(19) United States
(12) Patent Application Publication
(10) Pub. No.: US 2022/0178494 A1
(43) Pub. Date: Jun. 9, 2022

(54) Stand for Maintaining Panels of Sheet Material in a Vertical Orientation

(71) Applicant: Richard M. Roche, Berlin, NH (US)

(72) Inventor: Richard M. Roche, Berlin, NH (US)

(21) Appl. No.: 17/457,746

(22) Filed: Dec. 6, 2021

Related U.S. Application Data
(60) Provisional application No. 63/122,284, filed on Dec. 7, 2020.

(51) Int. Cl. F16M 11/22

(52) U.S. Cl. CPC F16M 11/22

(57) ABSTRACT

One aspect of the present disclosure is a stand for supporting one or more panels of sheet material. The stand preferably includes a base portion configured to be disposed on and supported by a floor surface, an upright portion extending relative to the floor surface at a predetermined angle when the base portion is disposed on the floor surface, and wherein the upright portion and the base portion are configured to support the one or more panels of sheet material in a vertical orientation based on the predetermined angle.

### RELATED APPLICATIONS

This application claims the benefit of U.S. Provisional Application No. 63/122,284 which was filed on Dec. 7, 2020 and is incorporated herein in its entirety by reference.

### TECHNICAL FIELD

This specification relates generally to stands for supporting panels of sheet material, and more specifically, a stand for supporting panels of sheet material such as sheetrock in a substantially vertical orientation.

### BACKGROUND INFORMATION

Prior approaches to storing panels of sheet material such as sheetrock prior to installation include stacking panels in a horizontal/flat manner. Such approaches put significant stress on the bodies of installation professionals, particularly in the back and knees. In addition, panels stacked horizontally tend to have a relatively large footprint given uncut sizes can be four feet by eight feet, for example. Given the overall footprint, it can be impractical to store sheet panels close to where they will be ultimately installed. Indeed, job sites with significant space constraints can require that panels be stored outside or at a location that requires each panel to be hauled individually to a place of installation. Other approaches include so-called “A-frame” stands with scissoring support legs/arms. However, such stands can be dangerous as the support portions can potentially collapse on a user's hand.

A need exists for a stand that can maintain panels of sheet material in a vertical orientation that reduces body strain/stress on installers/professionals, reduces the overall footprint to store such panels, and that provides increased safety and accessibility to the panels for purposes of adding/removing panels and/or for performing measurement routines on panel(s) stored in the vertical orientation.

### BRIEF DESCRIPTION OF DRAWINGS

The accompanying drawings are provided to illustrate some, but not all, embodiments of the present disclosure to facilitate the understanding of the present disclosure. The drawings are parts of the present disclosure. The illustrative embodiments and the descriptions are for explaining the principles of the present disclosure and are not intended to limit the scope of the present disclosure. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a perspective view of an example stand consistent with aspects of the present disclosure.

FIG. 2 shows a side view of the example stand of FIG. 1 consistent with aspects of the present disclosure.

FIG. 3 shows a back view of the example stand of FIG. 1 consistent with aspects of the present disclosure.

FIG. 4 shows a top view of the example stand of FIG. 1 consistent with aspects of the present disclosure.

FIG. 5 shows an enlarged tread region of a stand consistent with aspects of the present disclosure.

FIG. 6 shows another side view of an example stand consistent with aspects of the present disclosure.

FIG. 7 shows a plurality of stands coupled together in accordance with aspects of the present disclosure.

FIG. 8A shows an example stand consistent with aspects of the disclosure.

FIG. 8B shows an example of a horizontal/flat stack of panels.

### DETAILED DESCRIPTION

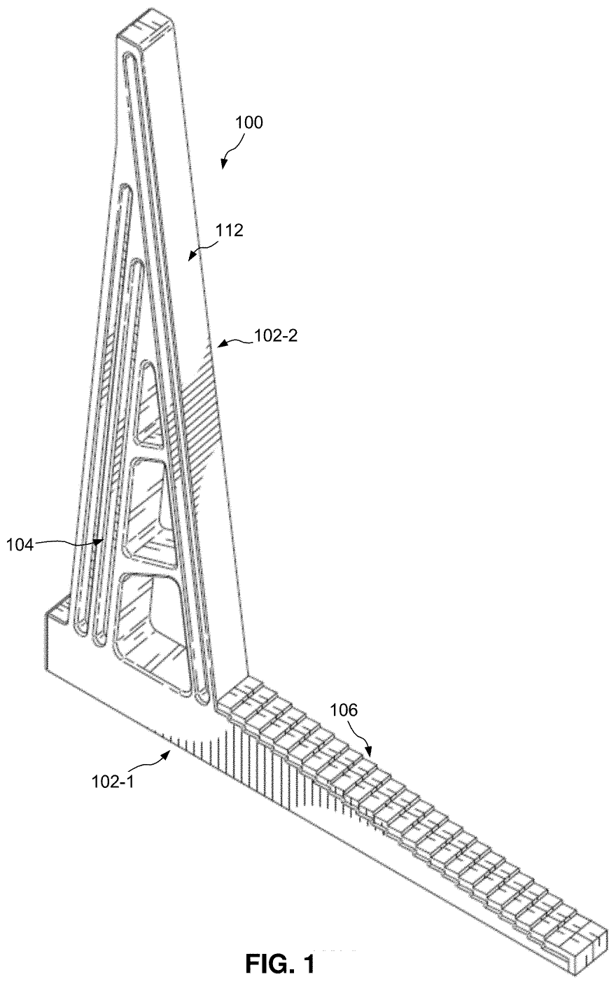

FIGS. 1-4 collectively show an example stand 100 in accordance with an embodiment of the present disclosure. The stand 100 is configured to preferably support panels of sheet material such as sheetrock, although other sheet materials are within the scope of this disclosure such as plywood. Accordingly, while the following discussion refers specifically to sheetrock panels, aspects and features of the present disclosure are equally applicable to other types of sheet materials that can be purchased in both standard dimensions such as 4′×8′, 4′×12′ and/or 4′×16′ and custom dimensions depending on a desired application.

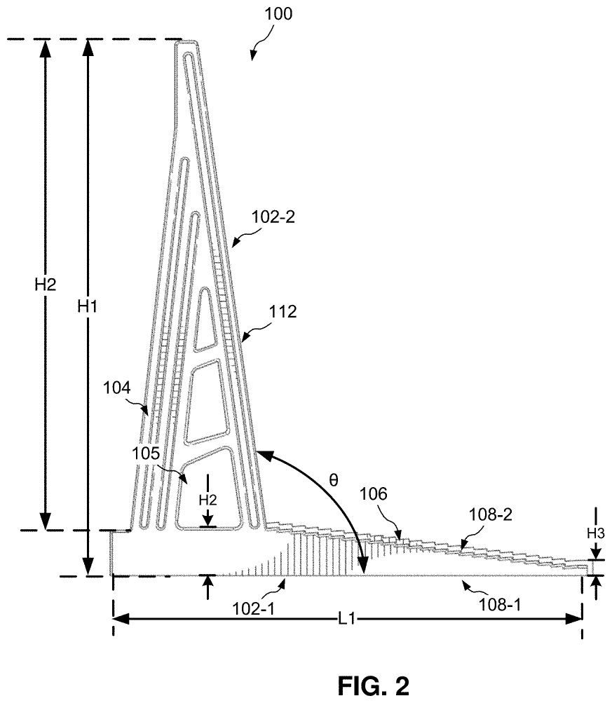

The stand 100 includes a base portion 102-1 and an upright portion 102-2 that extends from the base portion 102-1 at a predetermined angle θ (FIG. 2) relative to a first surface 108-1 (which may also be referred to herein as a bottom surface) of the base portion 102-1. Preferably, the first surface 108-1 is a planar surface that extends parallel with the surface/floor underlying the base portion 102-1. The predetermined angle θ measures preferably between 85-110 degrees, 90-100 degrees, and more preferably 94 degrees±3 degrees.

The predetermined angle θ allows for the stand 100 to maintain panels of sheet material in a vertical orientation. As generally referred to herein, the term vertical orientation refers to panels of sheet material being supported by a stand consistent with the present disclosure at an angle relative to the floor surface based on the predetermined angle θ of the base portion 102-1 and upright portion 102-2 discussed above.

In any such cases, the stand 100 preferably includes an L-shaped profile based on the base portion 102-1 and the upright portion 102-2 extending from the same at the predetermined angle θ.

The base portion 102-1 and the upright portion 102-2 are preferably constructed from a single, monolithic piece of material. However, other configurations are within the scope of this disclosure and the base portion 102-1 and the upright portion 102-2 may be formed as separate pieces from the same or different material. In one preferred example, the base portion 102-1 and the upright portion 102-2 comprise a metal such as carbon steel although other materials are within the scope of this disclosure such as alloy steel.

The base portion 102-1 includes a first surface 108-1 disposed opposite a second surface 108-2. The first surface 108-1 may also be referred to as a bottom surface and the second surface 108-2 may also be referred to as a top surface.

The first surface 108-1 can be configured to (directly) engage a floor surface to transfer load from one or more panels of sheet material disposed on the base portion 102-1 to the floor. The first surface 108-1 can include a smooth profile, or be textured to increase friction with the floor surface. In one example, the first surface 108-1 can include a layer of material disposed thereon (not shown) such as rubber to increase friction with the floor surface.

The second surface 108-2 preferably defines a tread region 106. The tread region 106 preferably includes a plurality of ridges/steps to engage an edge of panels of sheet material and prevent movement of the same when stored on the stand 100, as is discussed in greater detail below.

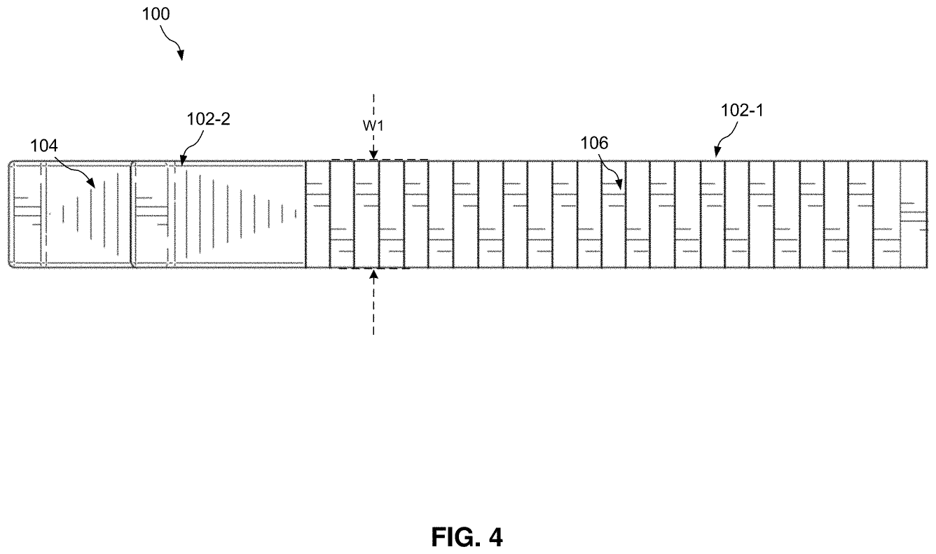

The base portion 102-1 can include an overall length of L1 (FIG. 2). The overall length L1 of the base portion 102-1 preferably measures in a range of 40 to 44 inches. The base portion 102-1 can include an overall width of W1 (FIG. 4). The overall width W1 of the base portion 102-2 preferably measures in a range of 4.5 to 5.5 inches.

This base portion 102-1 can include an overall height H2 (FIG. 2). The overall height H2 of the base portion 102-2 preferably measures in a range of 3 to 4 inches. Preferably, and as shown, the base portion 102-1 transitions from the overall height H2 to a third height H3, with the third height H3 being less than the overall height H2 to provide a taper. The third height H3 preferably measures in a range of 1±0.5 inches.

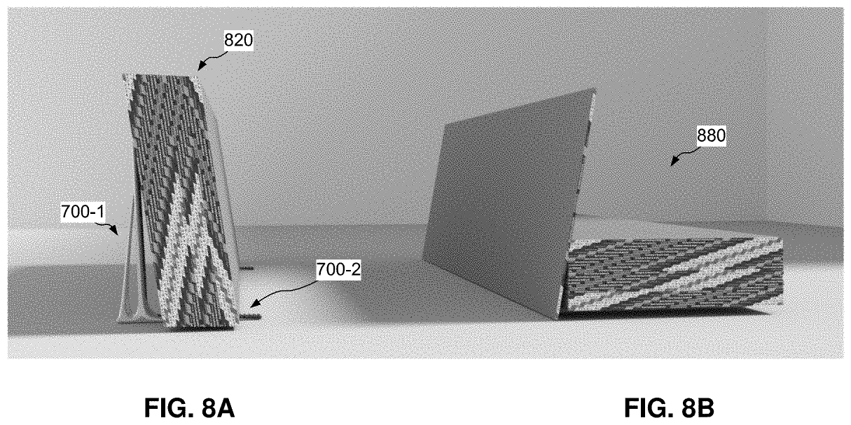

The upright portion 102-2 preferably includes a support surface 112. The support surface is preferably configured to support one or more panels of sheet material (see FIG. 8A). The support surface is preferably configured to extend along the length of the upright portion 102-2.

The upright portion 102-2 preferably also includes a support structure 104 disposed opposite the support surface 112. The support structure 104 preferably includes one end adjacent a floor surface that supports the stand 100 and a second end coupled at a midpoint of the upright portion 102-2. The support structure 104 may include a uniform width from end to end, or can vary depending on a desired configuration.

The support structure 104 is preferably formed from the same material as the upright portion 102-2, although this disclosure is not necessarily limited in this regard. The support structure 104 may advantageously increase structural integrity of the upright portion 102-2. Preferably, the support structure defines at least one gap/opening 105, and more preferably a plurality of gaps/openings such as shown in FIG. 2. The at least one gap 105 may advantageously reduce the overall amount of weight of the stand 100 while providing structural reinforcement via the support structure 104.

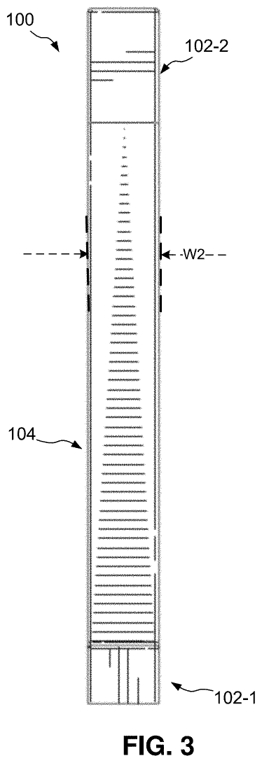

The upright portion 102-2 preferably extends from the base portion 102-1 to a height H2. The height h2 preferably measures in a range of 36 to 48 inches, and more preferably, at least 48 inches. The overall height H1 of the upright portion 102-2 preferably measures between 46 and 47.5 inches, and more preferably at least 50 inches. The overall width W2 of the upright portion 102-2 measures preferably in a range of 4.5 to 6.5 inches and more preferably at least 5.5 inches (See FIG. 3). In one example, the ratio of the overall width W2 of the upright portion 102-2 relative to the overall height H1 is 5:1, 4:1, 3:1, or 2:1. In one preferred example, this can include the overall width W2 being 5 inches and the overall height H1 being 50 inches such that the ratio of W2 to H1 is 1:5.

In one example, the overall height H1 of the upright portion 102-2 is configured to extend between about 1 to 3 inches below the top edge of a pane/sheet of material disposed on the stand 100.

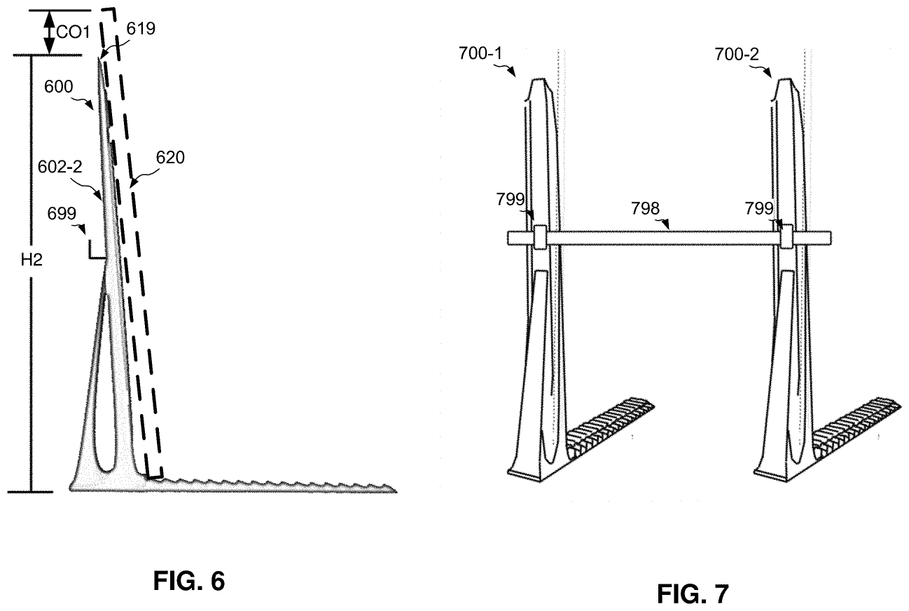

FIG. 6 shows another example stand 600 consistent with aspects of the present disclosure. The stand 600 can be configured substantially similar to the stand 100 of FIGS. 1-4, the various features and description of which is equally applicable to the stand 600 and for this reason will not be repeated for brevity. The stand 600 includes a base portion 602-1 and an upright portion 602-2.

As shown more clearly in FIG. 6, and in the context of a standard 4×8 panel 620 of sheet rock 120 disposed on edge against a stand 600, the overall height H2 preferably measures about four feet such that there is about a clearance offset CO1 between the top edge 119 (or distal end) of the upright portion 602-2 and the top edge of the panel 620. Preferably, the clearance offset CO1 measures in a range of 1 to 1.5 inches, and more preferably at least 1.5 inches.

Thus, an installer/professional may then grip the panel of sheet material 620 such that their fingers extend over the top edge of the same and wrap around towards the top edge 619 of the stand 600 without the risk that their fingers will engage the same and cause injury. This may advantageously allow for certain measurement routines to be conducted by an installer/professional without the risk of inadvertent injury. Consider the following example. As an installer looks at the wall framing he will be installing the sheetrock over, he may then take a center measure of stud material and then transfer a line onto the sheetrock indicating where the stud is behind the panel material to be used. By holding the tape measure in one hand and gliding it across the factory edge, also referred to as the seam edge, while simultaneously extending the tape hook parallel to material while holding a pencil/pen/marker tightly to the tape hook and beginning at one end of the sheetrock and then walking to the other end while marking the sheetrock at the desired measurements.

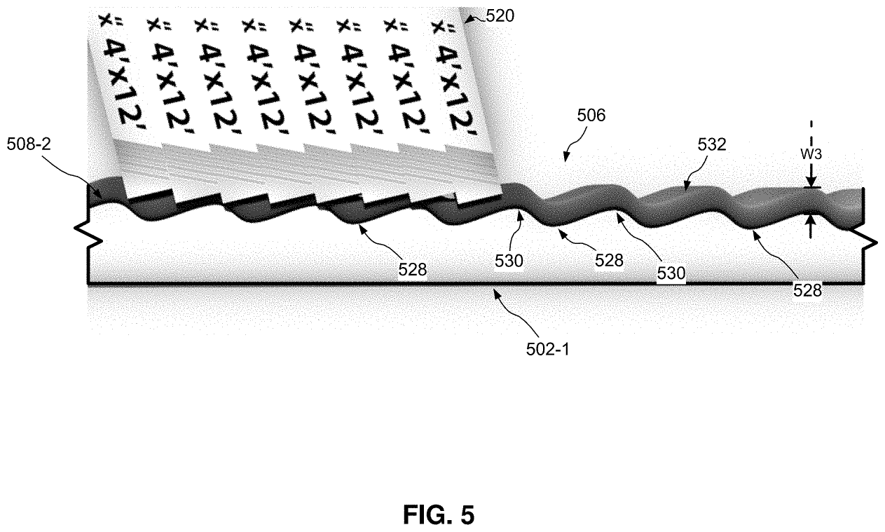

Turning to FIG. 5, an example of a base portion 502-2 is shown that can be used as the base portion 102-1 (see FIG. 1) or the base portion 602-1 (see FIG. 6). As shown, the base portion 502-1 defines a tread region 506. The tread region 506 preferably defines a plurality of grooves/channels 528 that preferably extend along the width of the base portion 502-1 and are configured to support one or more panels of sheet material 520.

Each groove of the plurality of grooves 528 can be recessed into the base portion 502-1 during manufacturing, e.g., via additive manufacturing, cutting routines, or other suitable method of forming the base portion 502-1. Preferably, the plurality of grooves 528 include curved profiles, such as shown in FIG. 5, although other profiles/shapes are within the scope of this disclosure. In any such cases, each groove can include sloped sidewalls that extend to peaks 530. The distance between each peak 530 (e.g. the peak-to-peak distance) is preferably uniform and measures in a range of 0.5 to 0.75 inches, for example, although other distances are within the scope of this disclosure. In one preferred example, the peak-to-peak distance for the peaks 530 is at least 1.25 inches to accommodate standard 4×8 foot sheetrock panels.

As further shown in FIG. 5, a deformable layer of material 532 is preferably disposed on the base portion 502-1. The deformable layer of material 532 preferably comprises rubber although other types of materials are within the scope of this disclosure such as silicone and other synthetic and non-synthetic materials. Preferably, the deformable layer of material 532 includes a shore D hardness value that is less than the material of the base portion 502-1. Note that the deformable layer of material 532 may be omitted such that the base portion 502-1 can provide the plurality of grooves 528. In this example, the panels of sheet material 520 may be disposed directly on the base portion 502-1.

Preferably, the deformable layer of material 532 is disposed across the entire width of a second (or top) surface 508-2 of the base portion 502-1. Preferably, the overall width W3 of the deformable layer of material 532 measures in a range of 0.0125 and 0.5 inches, and more preferably, at least 0.25 inches.

The deformable layer of material 532 preferably conforms to the shape of the grooves 528 of the base portion 502-1 such that the base portion 502-1 and the deformable layer of material 532 collectively provide the grooves 528. However, it should be noted that the deformable layer of material 532 may be pre-formed, e.g., via a mold, to include the grooves as shown in FIG. 5 in scenarios where, for instance, the second surface 508-2 is substantially flat.

More preferably, the deformable layer of material 532 is configured to be compressed under the weight of the panels of sheet material 520 and generate friction therebetween that prevents or otherwise significantly reduces movement of the panels of sheet materials 520 disposed thereon. More preferably, the deformable layer of material 532 allows for a zero, or near-zero gap between each panel of the panels of sheet material 520 such as shown in FIG. 5. This advantageously reduces wasted space between panels of sheet material and the potential for wind to get between the panels and cause the same to dangerously shift/lean away from the upright portion 502-2.

Returning to FIG. 6, the stand 600 is illustrated with an optional anchor structure 699. In certain scenarios it may be desirable utilize two or more stands in combination to support panels of sheet material. To increase structural stability, the optional anchor structure 699 may be utilized to couple together adjacent stands consistent with the present disclosure. As shown in FIG. 6, the anchor structure 699 can include a hook although other structures are within the scope of this disclosure.

For example, as shown in FIG. 7, a first stand 700-1 consistent with the present disclosure is disposed adjacent a second stand 700-2 consistent with the present disclosure. Note, the first stand 700-1 and the second stand 700-2 can be implemented as the stand 100 of FIGS. 1-4 and/or the stand 600 of FIG. 6. A bar 798 preferably extends between the first stand 700-1 and the second stand 700-2 and couples at each end to an associated anchor structure 799 of the first and second stands 700-1, 700-2. Note, N number of stands may be coupled together in this manner, although two or more stands may be utilized together without necessarily coupling stands together as shown in FIG. 7.

FIG. 8A shows an example of first and second stands 700-1, 700-2 configured consistent with the present disclosure. As shown, the first and second stands 700-1, 700-2 can support panels of sheet material 820 in a vertical orientation. This vertical orientation advantageously reduces body strain/stress and inconvenience of storing and working with the panels of sheet material 820. Conversely, the prior approach shown generally at 880 in FIG. 8B includes disposing panels of sheet material in a flat/horizontal orientation, which introduces significant body strain/stress on installers/professionals.

In accordance with an aspect of the present disclosure a stand for supporting one or more panels of sheet material is disclosed. The stand comprising a base portion configured to be disposed on and supported by a floor surface, an upright portion extending relative to the floor surface at a predetermined angle when the base portion is disposed on the floor surface, and wherein the upright portion and the base portion are configured to support the one or more panels of sheet material in a vertical orientation based on the predetermined angle.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. It will be appreciated by a person skilled in the art that a stand for supporting panels of sheet material consistent with the present disclosure may embody any one or more of the features contained herein and that the features may be used in any particular combination or sub-combination. Modifications and substitutions by one of ordinary skill in the art are considered to be within the scope of the present disclosure, which is not to be limited except by the claims.

1-11. (canceled)

12. A stand for supporting one or more panels of sheet material, the stand comprising:
a base,
the base having a top surface and a bottom surface, the bottom surface of the base being configured to be disposed on a floor surface, the top surface of the base having a tread region including a plurality of grooves, each of the plurality of grooves being configured to receive an edge of an associated of the one or more panels of sheet material,
the base having a first end and a second end, the height of the base above the floor surface at the first end of the base being a first height and the height of the base above the floor surface at the second end of the base being a second height, the first height being greater than the second height; and
an upright extending upwardly from the top surface of the base adjacent the first of the base,
the upright having a support surface and a rear surface,
wherein the tread region of the base extends between the upright and second end of the base, and
wherein the support surface of the upright and the base are configured to support the one or more panels of sheet material in a vertical orientation, each of the one or more panels being supported on an associated one of the plurality of grooves of the tread region.

13. The stand of claim 12, further comprising a support structure extending from the top surface of the base adjacent first end to the rear surface of the upright.

14. The stand of claim 12, wherein the height of the base tapers downwardly from a first end of the tread region adjacent the upright to a second end of the tread region adjacent the second end of the base.

15. The stand of claim 12, wherein the upright further includes an anchor structure for receiving a bar to anchor the stand to another stand.

16. The stand of claim 12, the stand further comprising a layer of a deformable material disposed on the grooves of the tread region.

17. The stand of claim 16, wherein the layer of deformable material comprises rubber.

18. The stand of claim 12, wherein the tread region is configured to support at least two panels of sheetrock in the vertical orientation and provide a zero or near-zero gap between the at least two panels of sheetrock based on the plurality of grooves.

19. The stand of claim 12, wherein the upright extends upwardly from the base at an angle between 90 degrees and 100 degrees relative to the floor surface.

20. The stand of claim 12, wherein the base and the upright are formed from a single monolithic piece of material.

21. A stand for supporting one or more panels of sheet material, the stand comprising:
a base,
the base having a top surface and a bottom surface, the bottom surface of the base being configured to be disposed on a floor surface, the top surface of the base having a tread region including a plurality of grooves, each of the plurality of grooves being configured to receive an edge of an associated of the one or more panels of sheet material,
the base having a first end and a second end, the height of the base above the floor surface at the first end of the base being a first height and the height of the base above the floor surface at the second end of the base being a second height, the first height being greater than the second height, the height of the base tapering downwardly in the tread region;
an upright extending upwardly from the top surface of the base adjacent the first of the base,
the upright having a support surface and a rear surface,
the upright including an anchor structure for receiving an anchor bar; and
a support structure extending from the top surface of the base adjacent the first end of the base to the rear surface of the upright,
wherein the tread region of the base extends between the upright and second end of the base, and
wherein the support surface of the upright and the base are configured to support the one or more panels of sheet material in a vertical orientation, each of the one or more panels being supported on an associated one of the plurality of grooves of the tread region.

22. The stand of claim 21, the stand further comprising a layer of a deformable material disposed on the grooves of the tread region.

23. The stand of claim 22, wherein the layer of deformable material comprises rubber.

24. The stand of claim 21, wherein the tread region is configured to support at least two panels of sheetrock in the vertical orientation and provide a zero or near-zero gap between the at least two panels of sheetrock based on the plurality of grooves.

25. The stand of claim 21, wherein the upright extends upwardly from the base at an angle between 90 degrees and 100 degrees relative to the floor surface.

26. The stand of claim 21, wherein the base, the upright, and the support structure are formed from a single monolithic piece of material.

27. A stand for supporting one or more panels of sheet material, the stand comprising:
a base,
the base having a top surface and a bottom surface, the bottom surface of the base being configured to be disposed on a floor surface, the top surface of the base having a tread region including a plurality of grooves, each of the plurality of grooves being configured to receive an edge of an associated of the one or more panels of sheet material, the base having a first end and a second end, the height of the base above the floor surface at the first end of the base being a first height and the height of the base above the floor surface at the second end of the base being a second height, the first height being greater than the second height, the height of the base tapering downwardly in the tread region;
an upright extending upwardly from the top surface of the base adjacent the first of the base an angle between 90 degrees and 100 degrees relative to the floor surface,
the upright having a support surface and a rear surface,
the upright including an anchor structure for receiving an anchor bar;
a support structure extending from the top surface of the base adjacent the first end of the base to the rear surface of the upright; and
a layer of a deformable material disposed on the grooves of the tread region,
wherein the tread region of the base extends between the upright and second end of the base, and
wherein the support surface of the upright and the base are configured to support the one or more panels of sheet material in a vertical orientation, each of the one or more panels being supported on an associated one of the plurality of grooves of the tread, and
and wherein the base, the upright and the support structure are formed of a single monolithic piece of material.

28. The stand of claim 27, wherein the tread region is configured to support at least two panels of sheetrock in the vertical orientation and provide a zero or near-zero gap between the at least two panels of sheetrock based on the plurality of grooves.
